(19) United States
(12) Patent Application Publication
(10) Pub. No.: US 2026/0318253 A1
(43) Pub. Date: Oct. 15, 2026

(54) GAS TURBINE CONTROL DEVICE, GAS TURBINE CONTROL METHOD, AND GAS TURBINE CONTROL PROGRAM

(71) Applicant: MITSUBISHI HEAVY INDUSTRIES, LTD., Tokyo (JP)

(72) Inventors: Takefumi TAKAHASHI, Tokyo (JP); Takashi SHIRAIWA, Tokyo (JP); Shinya UCHIDA, Tokyo (JP); Mitsuhiro MORISHITA, Tokyo (JP); Rei IKEDA, Tokyo (JP); Atsuhiko KANEBAKO, Tokyo (JP); Shinichi YAMAZAKI, Tokyo (JP)

(21) Appl. No.: 19/117,167

(22) PCT Filed: Sep. 29, 2023
(86) PCT No.: PCT/JP2023/035603

§ 371 Date: Mar. 31, 2025

(30) Foreign Application Priority Data
Oct. 17, 2022 (JP) 2022-166116

(51) Int. Cl. F02C 9/40; F02C 9/28; F23R 3/36

(52) U.S. Cl. CPC F02C 9/40; F02C 9/28; F23R 3/36

(57) ABSTRACT

This gas turbine control device controls a gas turbine comprising a combustor capable of generating combustion gas for driving the gas turbine by cofiring a first fuel and a second fuel. When it is determined that the supply of the second fuel to the combustor is being at least partly shut off, the present device calculates a shutoff-time fuel flow rate to be supplied to the combustor in accordance with a fuel cofiring ratio after the second fuel is at least partly shut off. Moreover, after the second fuel is at least partly shut off, the device outputs a fuel flow rate command value corresponding to the shutoff-time fuel flow rate, before reaching the fuel cofiring ratio.

### TECHNICAL FIELD

The present disclosure relates to a gas turbine control device, a gas turbine control method, and a gas turbine control program.

The present application claims the benefit of priority based on Japanese Patent Application No. 2022-166116 filed to the Japanese Patent Office on Oct. 17, 2022, the content of which is incorporated herein by reference.

### BACKGROUND ART

A gas turbine power generation facility that generates power by driving a turbine to which a generator is connected using a combustion gas generated by combusting fuel is known. In recent years, due to the increase in awareness of environmental issues, natural gas, which is clean energy, may be used as fuel in this type of gas turbine power generation facility. The natural gas is mined from a gas field or the like as raw material natural gas, and is liquefied and purified to be used as liquefied natural gas (LNG).

For example, PTL 1 discloses a technique related to a gas turbine that is used by mixing liquefied natural gas with a boil-off gas (BOG) which is a low calorie gas generated in a storage facility or the like of the liquefied natural gas, as fuel of the gas turbine. It is described in this literature that, in a case where the calorific value of the fuel supplied to the gas turbine is increased due to the stop of the supply of the boil-off gas for some reason, the operation state of the gas turbine is stabilized by reducing the fuel flow rate supplied to the gas turbine.

### CITATION LIST

### Patent Literature

[PTL 1] Japanese Unexamined Patent Application Publication No. 2014-227886

### SUMMARY OF INVENTION

### Technical Problem

In a gas turbine that co-fires fuel gases having different combustion characteristics, in a case where a supply system of a part of the fuel gases is stopped due to some failure or problem, the combustion characteristics of the fuel gases may be changed, which may hinder stable operation of the gas turbine. For example, in a case where hydrogen gas having a low calorific value per unit volume is mixed with natural gas and combusted in a gas turbine, and at least a part of a hydrogen gas supply system is stopped, a ratio of the natural gas having a high calorific value per unit volume in the fuel supplied to the gas turbine is increased. As a result, a turbine heat input amount increases, and thus over-fire or the like, in which a turbine inlet temperature rapidly increases, occurs.

In the above PTL 1, in a case where the supply of boil-off gas mixed with the liquefied natural gas is stopped, the fuel flow rate to the gas turbine is reduced to stabilize the operation state of the gas turbine. However, in this literature, the fuel flow rate is adjusted to correspond to the transition of the calorific value of the fuel supplied to the gas turbine due to the stop of the supply of the boil-off gas, and it is difficult to suppress a sudden phenomenon such as the over-fire.

At least one embodiment of the present disclosure has been made in view of the above circumstances, and an object thereof is to provide a gas turbine control device, a gas turbine control method, and a gas turbine control program capable of suppressing an influence due to a change in a turbine heat input amount in a case where at least a part of a fuel having a low calorific value per unit volume included in a fuel supplied to a combustor of a gas turbine is shut off.

### Solution to Problem

In order to achieve the above object, according to at least one embodiment of the present disclosure,
there is provided a gas turbine control device that controls a gas turbine including a combustor capable of generating a combustion gas for driving the gas turbine by co-firing a first fuel and a second fuel having a lower calorific value per unit volume than the first fuel, the gas turbine control device including:
a supply state determination unit that determines a supply state of the second fuel to the combustor;
a shutoff-time fuel flow rate calculation unit that calculates, in a case where the supply state where at least a part of the second fuel to the combustor is shut off is determined, a shutoff-time fuel flow rate to be supplied to the combustor corresponding to a fuel co-firing ratio after the at least a part of the second fuel is shut off; and
a fuel command value output unit that outputs a fuel flow rate command value corresponding to the shutoff-time fuel flow rate before the fuel co-firing ratio is obtained after the at least a part of the second fuel is shut off.

In order to achieve the above object, according to at least one embodiment of the present disclosure,
there is provided a gas turbine control method of controlling a gas turbine including a combustor capable of generating a combustion gas for driving the gas turbine by co-firing a first fuel and a second fuel having a lower calorific value per unit volume than the first fuel, the gas turbine control method including:

a step of determining a supply state of the second fuel to the combustor;
a step of calculating, in a case where the supply state where at least a part of the second fuel to the combustor is shut off is determined, a shutoff-time fuel flow rate to be supplied to the combustor corresponding to a fuel co-firing ratio after the at least a part of the second fuel is shut off; and
a step of outputting a fuel flow rate command value corresponding to the shutoff-time fuel flow rate before the fuel co-firing ratio is obtained after the at least a part of the second fuel is shut off.

In order to achieve the above object, according to at least one embodiment of the present disclosure,
there is provided a gas turbine control program for controlling a gas turbine including a combustor capable of generating a combustion gas for driving the gas turbine by co-firing a first fuel and a second fuel having a lower calorific value per unit volume than the first fuel, the gas turbine control program causing a computer device to execute:
a step of determining a supply state of the second fuel to the combustor;
a step of calculating, in a case where the supply state where at least a part of the second fuel to the combustor is shut off is determined, a shutoff-time fuel flow rate to be supplied to the combustor corresponding to a fuel co-firing ratio after the at least a part of the second fuel is shut off; and
a step of outputting a fuel flow rate command value corresponding to the shutoff-time fuel flow rate before the fuel co-firing ratio is obtained after the at least a part of the second fuel is shut off.

### Advantageous Effects of Invention

According to at least one embodiment of the present disclosure, it is possible to provide a gas turbine control device, a gas turbine control method, and a gas turbine control program capable of suppressing an influence due to a change in a turbine heat input amount in a case where at least a part of a fuel having a low calorific value per unit volume included in a fuel supplied to a combustor of a gas turbine is shut off.

### BRIEF DESCRIPTION OF DRAWINGS

FIG. 1 is a diagram illustrating a schematic configuration of a gas turbine according to one embodiment.

FIG. 2 is a block diagram illustrating a functional configuration of a gas turbine control device according to one embodiment.

FIG. 3 is a flowchart illustrating a gas turbine control method according to one embodiment.

FIG. 4 is a time chart illustrating a control state of each configuration of the gas turbine corresponding to FIG. 3.

### DESCRIPTION OF EMBODIMENTS

Hereinafter, some embodiments of the present invention will be described with reference to the accompanying drawings. Meanwhile, configurations described in the embodiments or illustrated in the drawings are not intended to limit the scope of the invention, and are merely examples for description.

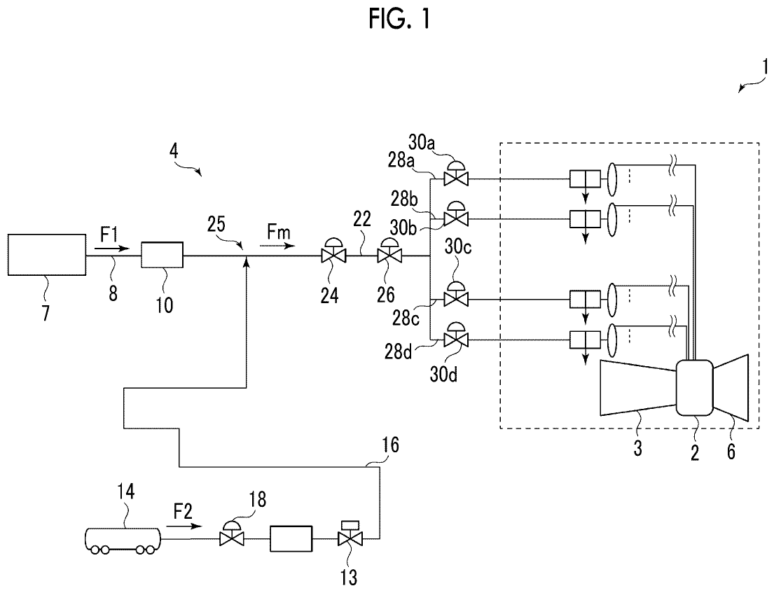

First, a gas turbine 1 which is a control target of a gas turbine control device 50 according to at least one embodiment of the present disclosure will be described with reference to FIG. 1. FIG. 1 is a diagram illustrating a schematic configuration of the gas turbine 1 according to one embodiment.

The gas turbine 1 includes a compressor 3 that generates compressed air, a combustor 2 that generates combustion gas by co-firing the compressed air generated by the compressor 3 with fuel, a fuel supply system 4 that supplies the fuel to the combustor 2, and a turbine 6 that is driven by the combustion gas. The compressor 3 and the turbine 6 are connected to each other on one shaft. In the gas turbine 1 having such a configuration, compressed air compressed by the compressor 3 and fuel supplied from the fuel supply system 4 are supplied to the combustor 2, and the compressed air and the fuel are mixed and combusted to generate combustion gas. The combustion gas flows into the turbine 6 and acts as power for rotating the turbine 6.

The fuel supply system 4 handles a mixed fuel in which a first fuel F1 and a second fuel F2 are mixed with each other as the fuel supplied to the combustor 2. The second fuel F2 is a fuel having a lower calorific value per unit volume than the first fuel F1. In the present embodiment, the first fuel F1 is liquefied natural gas, and the second fuel F2 is hydrogen gas.

The first fuel F1 is supplied through a first fuel supply line 8 connected to a first fuel supply source 7. A flowmeter 10 for detecting the flow rate of the first fuel F1 is provided in the first fuel supply line 8.

The second fuel F2 is supplied through a second fuel supply line 16 connected to a second fuel supply source 14. The second fuel supply line 16 is provided with a first flow regulation valve 18 for adjusting the flow rate of the second fuel F2 and a shutoff valve 13 for shutting off the second fuel F2.

The first fuel supply line 8 and the second fuel supply line 16 are connected to a main fuel supply line 22 by joining to each other on a downstream side. The first fuel F1 and the second fuel F2 are mixed by being joined at a joining point 25 of the first fuel supply line 8 and the second fuel supply line 16, and the mixed fuel (hereinafter, referred to as “mixed fuel Fm” as appropriate) is sent by the main fuel supply line 22.

In the main fuel supply line 22, a shutoff valve 24 that shuts off the mixed fuel Fm and a second flow regulation valve 26 that adjusts the flow rate of the mixed fuel Fm are provided.

The downstream side of the main fuel supply line 22 is branched into a plurality of fuel branch supply lines 28a, 28b, . . . so as to correspond to a plurality of fuel injection nozzles (not illustrated) provided in the combustor 2. The plurality of fuel injection nozzles may include a main fuel injection nozzle, a pilot fuel injection nozzle, a top hat fuel injection nozzle, and the like. In this case, at least a part of the main fuel injection nozzles may be grouped. The plurality of fuel branch supply lines 28a, 28b, . . . are respectively provided with a third flow regulation valve 30a, 30b, . . . for adjusting the flow rate of the mixed fuel flowing through each line.

Subsequently, a gas turbine control device 50 for controlling the gas turbine 1 having the above-described configuration will be described. The gas turbine control device 50 is a control unit that controls the gas turbine 1, and is configured with, for example, a central processing unit (CPU), a random-access memory (RAM), a read-only memory (ROM), and a computer-readable storage medium. A series of processing for realizing various functions is stored in a storage medium or the like in the form of a program, as an example, and the CPU reads out this program to a RAM or the like, and executes processing for information processing and calculation, whereby various functions are realized. A form installed in advance in the ROM or other storage medium, a form provided in a state of being stored in a computer-readable storage medium, or a form of being delivered via wired or wireless communication means may be applied as the program. The computer-readable storage medium is a magnetic disk, a magneto-optical disk, a CD-ROM, a DVD-ROM, a semiconductor memory, or the like.

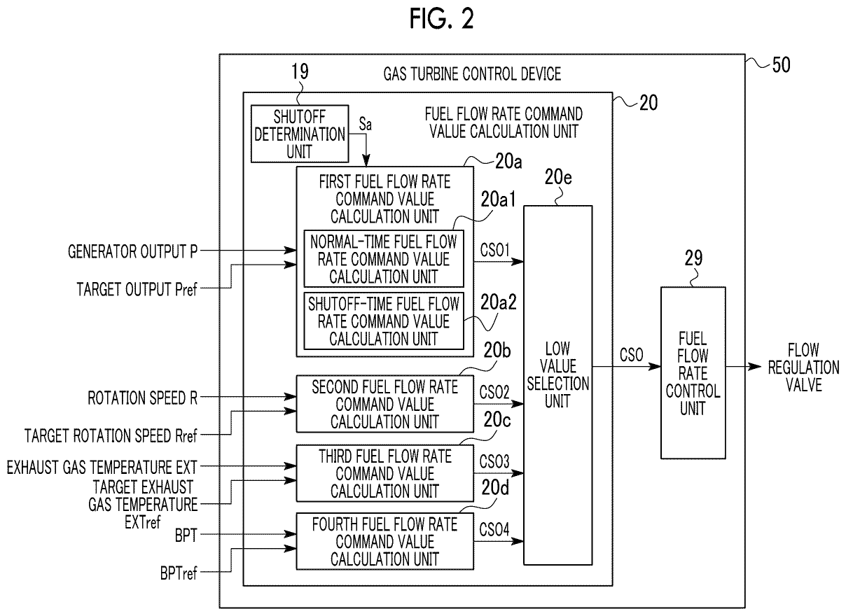

FIG. 2 is a block diagram illustrating a functional configuration of the gas turbine control device 50 according to one embodiment. The gas turbine control device 50 includes a shutoff determination unit 19, a fuel flow rate command value calculation unit 20, and a fuel flow rate control unit 29.

The shutoff determination unit 19 has a configuration of determining whether or not at least a part of the second fuel F2 is shut off in the fuel supply system 4. For example, the shutoff determination unit 19 determines whether or not at least a part of the second fuel F2 is shut off based on an opening/closing state of the shutoff valve 21 provided in the second fuel supply line 16 through which the second fuel F2 flows.

In the fuel supply system 4 illustrated in FIG. 1, a case where the second fuel F2 is supplied from the single second fuel supply source 14 through the single second fuel supply line 16 is exemplified, and the shutoff valve 13 is closed in a case where the supply of the second fuel F2 from the second fuel supply source 14 is impossible due to some factor or where the second fuel supply line 16 is shut off. The shutoff determination unit 19 outputs a shutoff detection signal Sa indicating that the second fuel F2 is shut off in a case where the shutoff determination unit 19 detects that the second fuel F2 is shut off based on the opening/closing state of the shutoff valve 21.

In the following description, the case where the second fuel F2 is completely shut off will be described as a situation where the second fuel F2 is shut off. However, for example, in a case where the second fuel supply line 16 is branched into a plurality of lines and the second fuel F2 can be supplied from a plurality of second fuel supply sources 14, at least a part of the second fuel F2 may be shut off by closing the shutoff valve 21 provided in a part of the second fuel supply line 16. In this case, the shutoff detection signal Sa is also a signal corresponding to the shutoff amount of the second fuel F2, and thus the shutoff detection signal Sa can be handled in the same manner.

The fuel flow rate command value calculation unit 20 acquires a state quantity (turbine output P, rotation speed R, exhaust gas temperature EXT, blade path temperature BPT, and the like) related to the operation state of the gas turbine 1 as the input signal, and outputs a fuel flow rate command value CSO obtained by the calculation. The fuel flow rate control unit 29 receives the fuel flow rate command value CSO from the fuel flow rate command value calculation unit 20 and adjusts the fuel flow rate supplied by the fuel supply system 4 based on the fuel flow rate command value CSO.

The fuel flow rate command value calculation unit 20 includes a first fuel flow rate command value calculation unit 20a, a second fuel flow rate command value calculation unit 20b, a third fuel flow rate command value calculation unit 20c, a fourth fuel flow rate command value calculation unit 20d, and a low value selection unit 20e. The first to fourth fuel flow rate command value calculation units 20a to 20d calculate the corresponding first to fourth fuel flow rate command values CSO1 to CSO4, respectively. The low value selection unit 20e selects and outputs the minimum one of the first fuel flow rate command value CSO1 to the fourth fuel flow rate command value CSO4 as the fuel flow rate command value SCO.

The first fuel flow rate command value calculation unit 20a includes a normal-time fuel flow rate command value calculation unit 20a1 and a shutoff-time fuel flow rate command value calculation unit 20a2 that can be switched between each other in accordance with an operation mode of the gas turbine 1. The switching between the normal-time fuel flow rate command value calculation unit 20a1 and the shutoff-time fuel flow rate command value calculation unit 20a2 is performed based on the shutoff detection signal Sa input to the first fuel flow rate command value calculation unit 20a from the shutoff determination unit 19.

In a case in which the fuel supply system 4 is in a normal state (that is, a state in which the second fuel F2 is not shut off based on the shutoff detection signal Sa), the first fuel flow rate command value calculation unit 20a calculates the first fuel flow rate command value CSO1 via the normal-time fuel flow rate command value calculation unit 20a1. In the normal-time fuel flow rate command value calculation unit 20a1, a turbine output P and a target turbine output Pref corresponding to the turbine output P are input from the input signal to the fuel flow rate command value calculation unit 20, and the first fuel flow rate command value CSO2 which is one candidate for the fuel flow rate command value CSO is calculated based on a deviation ΔP therebetween.

In the calculation of the first fuel flow rate command value CSO in the normal-time fuel flow rate command value calculation unit 20a1, the correlation between the deviation ΔP and the first fuel flow rate command value CSO1 is prepared in advance, and the corresponding first fuel flow rate command value CSO1 is obtained by inputting the deviation ΔP to the correlation. This correlation is prepared in advance in accordance with a fuel co-firing ratio of the first fuel F1 and the second fuel F2 acquired from the fuel supply system 4.

In a case in which the fuel supply system 4 is in a shutoff state (that is, a state in which at least a part of the second fuel F2 is shut off based on the shutoff detection signal Sa), the first fuel flow rate command value calculation unit 20a calculates the first fuel flow rate command value CSO1 via the shutoff-time fuel flow rate command value calculation unit 20a2. In the shutoff-time fuel flow rate command value calculation unit 20a2, the turbine output P and the target turbine output Pref corresponding to the turbine output P are input from the input signal to the fuel flow rate command value calculation unit 20, and the first fuel flow rate command value CSO2, which is one candidate for the fuel flow rate command value CSO, is calculated based on the deviation ΔP therebetween.

In the calculation of the first fuel flow rate command value CSO by the shutoff-time fuel flow rate command value calculation unit 20a2, the correlation between the deviation ΔP and the first fuel flow rate command value CSO1 is prepared in advance, and the corresponding first fuel flow rate command value CSO1 is obtained by inputting the deviation ΔP to the correlation. This correlation is prepared in advance corresponding to the fuel co-firing ratio corresponding to a case where it is assumed that at least a part of the second fuel F2 is shut off to correspond to the shutoff signal Sa in the fuel supply system 4.

The second fuel flow rate command value calculation unit 20b is configured to calculate a second fuel flow rate command value CSO2 that is one candidate for the fuel flow rate command value CSO. In the second fuel flow rate command value calculation unit 20b, the rotation speed R and a target rotation speed Rref corresponding to the rotation speed R are input from the input signal to the fuel flow rate command value calculation unit 20, and the second fuel flow rate command value CSO2 is calculated based on the deviation AR therebetween.

The third fuel flow rate command value calculation unit 20c is configured to calculate a third fuel flow rate command value CSO3 which is one candidate for the fuel flow rate command value CSO. In the third fuel flow rate command value calculation unit 20c, an exhaust gas temperature EXT and a target exhaust gas temperature EXTref corresponding to the exhaust gas temperature EXT are input from the input signal to the fuel flow rate command value calculation unit 20, and the third fuel flow rate command value CSO3 is calculated based on a deviation ΔEXT therebetween.

The fourth fuel flow rate command value calculation unit 20d is configured to calculate a fourth fuel flow rate command value CSO4 which is one candidate of the fuel flow rate command value CSO. In the fourth fuel flow rate command value calculation unit 20d, the blade path temperature BPT and a target blade path temperature BPTref corresponding to the blade path temperature BPT are input from the input signal to the fuel flow rate command value calculation unit 20, and the fourth fuel flow rate command value CSO4 is calculated based on a deviation ΔBPT therebetween.

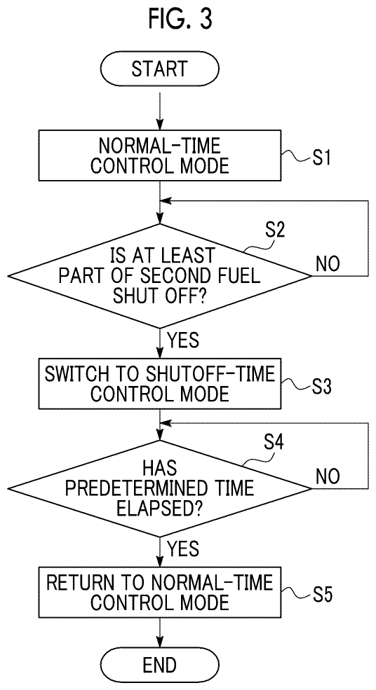

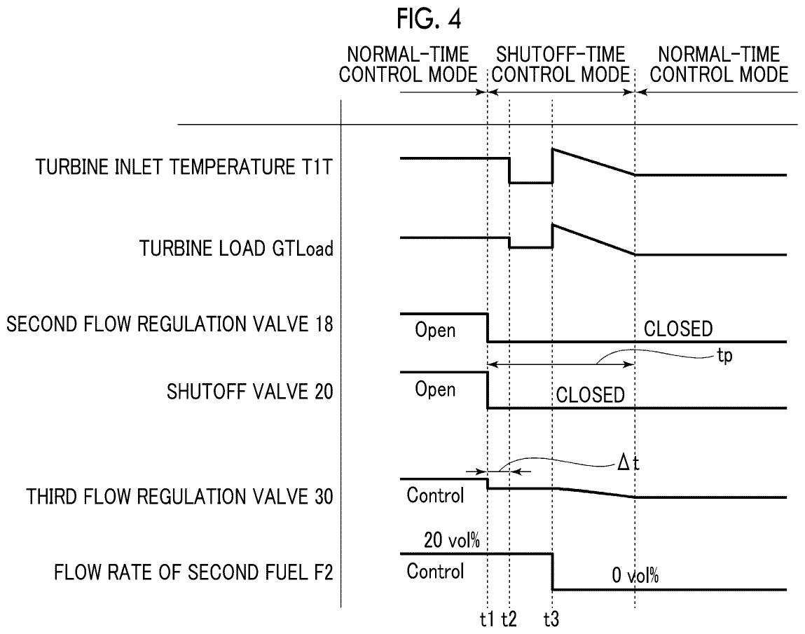

Subsequently, a turbine control method performed by the gas turbine control device 50 having the above configuration will be described. FIG. 3 is a flowchart illustrating a gas turbine control method according to one embodiment, and FIG. 4 is a time chart illustrating control states of each configuration of the gas turbine 1 corresponding to FIG. 3.

First, the gas turbine control device 50 controls the gas turbine 1 in a normal-time control mode (Step S1). In the normal-time control mode, the first fuel F1 and the second fuel F2 are both normally supplied in the fuel supply system 4, and the mixed fuel Fm is supplied to the combustor 2. In this case, the first fuel flow rate command value calculation unit 20a calculates the first fuel flow rate command value CSO1 via the normal-time fuel flow rate command value calculation unit 20a1.

It should be noted that, in the present embodiment, for the sake of description, a case where the first fuel flow rate command value CSO1 is always selected as the fuel flow rate command value CSO in the low value selection unit 20e by making the second fuel flow rate command value CSO2 to the fourth fuel flow rate command value CSO4 larger than the first fuel flow rate command value CSO1 in the fuel flow rate command value calculation unit 20a will be described.

Subsequently, the shutoff determination unit 19 determines whether or not at least a part of the second fuel F2 is shut off in the fuel supply system 4 (Step S2). In Step S2, in the gas turbine 1 controlled in the normal-time control mode, it is determined whether or not the second fuel F2 is shut off by monitoring the fuel supply system 4. Such determination can be made, for example, based on the opening degree of the shutoff valve 21 disposed in the second fuel supply line 16 provided in the fuel supply system 4.

In a case where the shutoff determination unit 19 determines that at least a part of the second fuel F2 is shut off (Step S2: YES), the gas turbine control device 50 switches the normal-time control mode to a shutoff-time control mode (Step S3). In the shutoff-time control mode, the first fuel flow rate command value CSO1 in the first fuel flow rate command value calculation unit 20a is calculated by the shutoff-time fuel flow rate command value calculation unit 20a2.

The shutoff-time fuel flow rate command value calculation unit 20a2 calculates the fuel co-firing ratio after the shutting off of the second fuel F2, and calculates the shutoff-time fuel flow rate that should be supplied to the combustor 2 in accordance with the fuel co-firing ratio to obtain the first fuel flow rate command value CSO1. In the present embodiment, the second fuel F2 is shut off, so that the fuel co-firing ratio after the shutting off is 100% for the first fuel F1. Therefore, in a case where it is assumed that the mixed fuel Fm is only the first fuel F1, the first fuel flow rate command value CSO1 corresponding to the shutoff-time fuel flow rate to be supplied to the combustor 2 is calculated.

The correlation between the shutoff-time fuel flow rate and the turbine output is prepared in advance for each fuel co-firing ratio. In the present embodiment, the correlation corresponding to the fuel co-firing ratio in a case where the first fuel F1 is shut off is prepared in advance, and the shutoff-time fuel flow rate corresponding to the current turbine output is calculated based on the correlation.

In FIG. 4, the shutoff determination unit 19 detects the shutting off of the second fuel F2 at a time t1, so that the first fuel flow rate command value CSO1 calculated by the normal-time fuel flow rate command value calculation unit 20a1 is switched to the first fuel flow rate command value CSO1 calculated by the shutoff-time fuel flow rate command value calculation unit 20a2. Since the second fuel F2 has a lower calorific value per unit volume than the first fuel F1, the first fuel command value CSO1 calculated by the shutoff-time fuel flow rate command value calculation unit 20a2 is lower than the first fuel flow rate command value CSO1 calculated by the normal-time fuel flow rate command value calculation unit 20a1. Here, the fuel supply system 4 has a predetermined distance from the shutoff valve 13 to the combustor 2, and there is a time lag from the shutting off of the second fuel F2 to the actual increase in the fuel co-firing ratio of the first fuel F1 in the combustor 2. In FIG. 4, the flow rate before the shutting off is the same as the flow rate in the combustor 2 until a time t3, and the fuel co-firing ratio is not changed. Meanwhile, the distance between the second flow regulation valve 26 and the combustor 2 for adjusting the flow rate of the mixed fuel Fm is shorter than the distance between the shutoff valve 13 and the combustor 2. Therefore, by switching to the first fuel flow rate command value CSO1 calculated by the shutoff-time fuel flow rate command value calculation unit 20a2 immediately after the shutting off of the shutoff valve 13, it is possible to reduce a heat input amount to the combustor before the fuel co-firing ratio of the first fuel F1 is actually increased by the combustor. In FIG. 4, at a time t2 at which a time difference At has elapsed from the time t1, a turbine inlet temperature TIT and a gas turbine load GTLoad are decreased.

Subsequently, the gas turbine control device 50 determines whether or not a predetermined time tp has elapsed since the switching to the shutoff-time control mode (Step S4). The predetermined time tp is set to be larger than a time from the time tl at which the second fuel F2 is shut off to a time at which the fuel co-firing ratio of the first fuel F1 is actually increased in the combustor. Therefore, since the shutoff-time control mode is continuously enabled from the time tl to the predetermined time tp, the turbine inlet temperature TIT is lower than that in the normal-time control mode, and thus the influence of the over-fire can be effectively suppressed. In FIG. 4, the predetermined time tp is set to a value larger than a time difference “t3−t1”. The influence of the reduction in the fuel flow rate of the second fuel F2 due to the shutting off of the shutoff valve 13 and the increase in the fuel co-firing ratio of the first fuel F1 appears in the combustor 2 at the time t3, and the turbine inlet temperature TIT and the gas turbine load GTLoad are sharply increased. However, since the flow rate of the mixed fuel is already limited compared with before the shutting off, and the heat input amount to the combustor 2 is also reduced, the over-fire is effectively suppressed.

Note that, immediately after the second fuel F2 is shut off, the second fuel F2 supplied before the shutting off remains on the downstream side of the joining point 25 in the main fuel supply line 22. Therefore, the time t3 at which the over-fire occurs is delayed by the time required for the second fuel F2 remaining in the main fuel supply line 22 from the time t1 at which the second fuel F2 is shut off to be consumed in the combustor 2. In Step S4, by continuing the shutoff-time control mode until the predetermined time tp elapses from the time t1, the flow rate of the mixed fuel Fm is limited to decrease the turbine inlet temperature TIT in advance until the time at which the influence of the over-fire occurs with the time lag, so that the influence can be mitigated.

Then, in a case where the predetermined time tp has elapsed after the mode is switched to the shutoff-time control mode (Step S4: YES), the gas turbine control device 50 returns the gas turbine 1 to the normal-time control mode from the shutoff-time control mode (Step S5). As described above, in a case where a sufficient period (predetermined time) elapses from the time tl, the control mode of the gas turbine 1 is returned to the normal-time control mode, so that the operation can smoothly return to the normal operation without the possibility of the occurrence of the over-fire.

As described above, according to the above-described embodiments, in a case where at least a part of the second fuel F2 co-fired with the first fuel F1 is shut off, the shutoff-time fuel flow rate corresponding to the fuel co-firing ratio after the shutting off is calculated, and the shutoff-time fuel flow rate is reflected in the fuel flow rate command value CSO before the change in the fuel co-firing ratio due to the shutting off occurs. Thereby, the fuel flow rate command value CSO is set to a value corresponding to the fuel co-firing value after shutting off at least a part of the second fuel F2 before the influence of the shutting off of at least a part of the second fuel F2 appears in the operation state of the gas turbine 1, so that the influence can be effectively mitigated even in a case where the over-fire occurs.

In addition, it is possible to appropriately replace the components in the embodiment described above with well-known components within the scope which does not depart from the concept of the present disclosure, and the embodiments described above may be appropriately combined with each other.

For example, contents disclosed in each of the embodiments are understood as follows.

(1) According to an aspect,
there is provided a gas turbine control device that controls a gas turbine including a combustor capable of generating a combustion gas for driving the gas turbine by co-firing a first fuel and a second fuel having a lower calorific value per unit volume than the first fuel, the gas turbine control device including:
a supply state determination unit that determines a supply state of the second fuel to the combustor;
a shutoff-time fuel flow rate calculation unit that calculates, in a case where the supply state where at least a part of the second fuel to the combustor is shut off is determined, a shutoff-time fuel flow rate to be supplied to the combustor corresponding to a fuel co-firing ratio after the at least a part of the second fuel is shut off; and
a fuel command value output unit that outputs a fuel flow rate command value corresponding to the shutoff-time fuel flow rate before the fuel co-firing ratio is obtained after the at least a part of the second fuel is shut off.

According to the aspect (1), in a case where at least a part of the second fuel co-fired with the first fuel is shut off, the shutoff-time fuel flow rate corresponding to the fuel co-firing ratio after the shutting off is calculated, and the shutoff-time fuel flow rate is reflected to the fuel flow rate command value before the change in the fuel co-firing ratio due to the shutting off occurs. Thereby, even in a case where the over-fire occurs, the influence thereof can be effectively mitigated by setting the fuel flow rate command value to the value corresponding to the fuel co-firing value after the shutting off before the influence of the shutting off of at least a part of the second fuel appears in the operation state of the gas turbine.

(2) In another aspect, in the aspect (1),
the shutoff-time fuel flow rate calculation unit calculates the shutoff-time fuel flow rate corresponding to a current output of the gas turbine based on a correlation between an output of the gas turbine and the shutoff-time fuel flow rate in a case of the fuel co-firing ratio.

According to the aspect (2), the correlation between the shutoff-time fuel flow rate and the output of the gas turbine in a case where at least a part of the second fuel is shut off is prepared in advance. In a case where at least a part of the second fuel is shut off in the gas turbine, the shutoff-time fuel flow rate corresponding to the current output of the gas turbine is calculated based on the correlation.

(3) In another aspect, in the aspect (1) or (2),
the shutoff-time fuel flow rate is effective for a predetermined time after the supply state where the at least a part of the second fuel to the combustor is shut off is determined.

According to the aspect (3), the shutoff-time fuel flow rate calculated in a case where at least a part of the second fuel is shut off is set to be effective for a predetermined time. Accordingly, even in a case where the over-fire occurs in the period, the influence thereof can be effectively mitigated.

(4) In another aspect, in the aspect (3),
the gas turbine control device further includes a target amount calculation unit that calculates a fuel flow rate to be supplied to the combustor based on a target output value and a current output value of the gas turbine,
in which the fuel command value output unit switches a control mode from a shutoff-time control mode in which the fuel flow rate command value corresponding to a total fuel flow rate to be supplied corresponding to the fuel co-firing ratio is output to a normal-time control mode in which the fuel flow rate command value is output using the fuel flow rate calculated by the target amount calculation unit, after the predetermined time elapses.

According to the aspect (4), after the predetermined time in which the shutoff-time fuel flow rate is effective has elapsed, the control mode is switched from the shutoff-time control mode to the normal-time control mode, so that the operation state of the gas turbine can be smoothly returned to the normal state.

(5) In another aspect, in any one of the aspects (1) to (4),
the first fuel is natural gas, and the second fuel is hydrogen gas.

According to the aspect (5), in the gas turbine in which the natural gas and the hydrogen gas are co-fired, in a case where at least a part of the hydrogen gas is shut off, it is possible to effectively suppress the influence of the change in the turbine heat input amount.

(6) According to an aspect,
there is provided a gas turbine control method of controlling a gas turbine including a combustor capable of generating a combustion gas for driving the gas turbine by co-firing a first fuel and a second fuel having a lower calorific value per unit volume than the first fuel, the gas turbine control method including:
a step of determining a supply state of the second fuel to the combustor;
a step of calculating, in a case where the supply state where at least a part of the second fuel to the combustor is shut off is determined, a shutoff-time fuel flow rate to be supplied to the combustor corresponding to a fuel co-firing ratio after the at least a part of the second fuel is shut off; and
a step of outputting a fuel flow rate command value corresponding to the shutoff-time fuel flow rate before the fuel co-firing ratio is obtained after the at least a part of the second fuel is shut off.

According to the aspect (6), in a case where at least a part of the second fuel co-fired with the first fuel is shut off, the shutoff-time fuel flow rate corresponding to the fuel co-firing ratio after the shutting off is calculated, and the shutoff-time fuel flow rate is reflected to the fuel flow rate command value before the change in the fuel co-firing ratio due to the shutting off occurs. Thereby, even in a case where the over-fire occurs, the influence thereof can be effectively mitigated by setting the fuel flow rate command value to the value corresponding to the fuel co-firing value after the shutting off before the influence of the shutting off of at least a part of the second fuel appears in the operation state of the gas turbine.

### (7) According to an Aspect,

there is provided a gas turbine control program for controlling a gas turbine including a combustor capable of generating a combustion gas for driving the gas turbine by co-firing a first fuel and a second fuel having a lower calorific value per unit volume than the first fuel, the gas turbine control program causing a computer device to execute:
a step of determining a supply state of the second fuel to the combustor;
a step of calculating, in a case where the supply state where at least a part of the second fuel to the combustor is shut off is determined, a shutoff-time fuel flow rate to be supplied to the combustor corresponding to a fuel co-firing ratio after the at least a part of the second fuel is shut off; and
a step of outputting a fuel flow rate command value corresponding to the shutoff-time fuel flow rate before the fuel co-firing ratio is obtained after the at least a part of the second fuel is shut off.

According to the aspect (7), in a case where at least a part of the second fuel co-fired with the first fuel is shut off, the shutoff-time fuel flow rate corresponding to the fuel co-firing ratio after the shutting off is calculated, and the shutoff-time fuel flow rate is reflected to the fuel flow rate command value before the change in the fuel co-firing ratio due to the shutting off occurs. Thereby, even in a case where the over-fire occurs, the influence thereof can be effectively mitigated by setting the fuel flow rate command value to the value corresponding to the fuel co-firing value after the shutting off before the influence of the shutting off of at least a part of the second fuel appears in the operation state of the gas turbine.

### REFERENCE SIGNS LIST

1: Gas turbine
2: Combustor
3: Compressor
4: Fuel supply system
6: Turbine
7: First fuel supply source
8: First fuel supply line
10: Flowmeter
13: Shutoff valve
14: Second fuel supply source
16: Second fuel supply line
18: First flow regulation valve
19: Shutoff determination unit
20: Fuel flow rate command value calculation unit
20a: First fuel flow rate command value calculation unit
20a1: Normal-time fuel flow rate command value calculation unit
20a2: Shutoff-time fuel flow rate command value calculation unit
20b: Second fuel flow rate command value calculation unit
20c: Third fuel flow rate command value calculation unit
20d: Fourth fuel flow rate command value calculation unit
20e: Low value selection unit
22: Main fuel supply line
25: Joining point
26: Second flow regulation valve
28a to 28d: Fuel branch supply line
29: Fuel flow rate control unit
30a to 30d: Third flow regulation valve
50: Gas turbine control device
F1: First fuel
F2: Second fuel
Fm: Mixed fuel

1. A gas turbine control device that controls a gas turbine including a combustor capable of generating a combustion gas for driving the gas turbine by co-firing a first fuel and a second fuel having a lower calorific value per unit volume than the first fuel, the gas turbine control device comprising:
a supply state determination unit that determines a supply state of the second fuel to the combustor;
a shutoff-time fuel flow rate calculation unit that calculates, in a case where the supply state where at least a part of the second fuel to the combustor is shut off is determined, a shutoff-time fuel flow rate to be supplied to the combustor corresponding to a fuel co-firing ratio after the at least a part of the second fuel is shut off; and
a fuel command value output unit that outputs a fuel flow rate command value corresponding to the shutoff-time fuel flow rate before the fuel co-firing ratio is obtained after the at least a part of the second fuel is shut off.

2. The gas turbine control device according to claim 1, wherein the shutoff-time fuel flow rate calculation unit calculates the shutoff-time fuel flow rate corresponding to a current output of the gas turbine based on a correlation between an output of the gas turbine and the shutoff-time fuel flow rate in a case of the fuel co-firing ratio.

3. The gas turbine control device according to claim 1, wherein the shutoff-time fuel flow rate is effective for a predetermined time after the supply state where the at least a part of the second fuel to the combustor is shut off is determined.

4. The gas turbine control device according to claim 3, further comprising a target amount calculation unit that calculates a fuel flow rate to be supplied to the combustor based on a target output value and a current output value of the gas turbine,
wherein the fuel command value output unit switches a control mode from a shutoff-time control mode in which the fuel flow rate command value corresponding to a total fuel flow rate to be supplied corresponding to the fuel co-firing ratio is output to a normal-time control mode in which the fuel flow rate command value is output using the fuel flow rate calculated by the target amount calculation unit, after the predetermined time elapses.

5. The gas turbine control device according to claim 1, wherein the first fuel is natural gas, and the second fuel is hydrogen gas.

6. A gas turbine control method of controlling a gas turbine including a combustor capable of generating a combustion gas for driving the gas turbine by co-firing a first fuel and a second fuel having a lower calorific value per unit volume than the first fuel, the gas turbine control method comprising:
a step of determining a supply state of the second fuel to the combustor;
a step of calculating, in a case where the supply state where at least a part of the second fuel to the combustor is shut off is determined, a shutoff-time fuel flow rate to be supplied to the combustor corresponding to a fuel co-firing ratio after the at least a part of the second fuel is shut off; and
a step of outputting a fuel flow rate command value corresponding to the shutoff-time fuel flow rate before the fuel co-firing ratio is obtained after the at least a part of the second fuel is shut off.

7. A gas turbine control program for controlling a gas turbine including a combustor capable of generating a combustion gas for driving the gas turbine by co-firing a first fuel and a second fuel having a lower calorific value per unit volume than the first fuel, the gas turbine control program causing a computer device to execute:
a step of determining a supply state of the second fuel to the combustor;
a step of calculating, in a case where the supply state where at least a part of the second fuel to the combustor is shut off is determined, a shutoff-time fuel flow rate to be supplied to the combustor corresponding to a fuel co-firing ratio after the at least a part of the second fuel is shut off; and
a step of outputting a fuel flow rate command value corresponding to the shutoff-time fuel flow rate before the fuel co-firing ratio is obtained after the at least a part of the second fuel is shut off.
